(19) United States
(12) Patent Application Publication
(10) Pub. No.: US 2022/0009850 A1
(43) Pub. Date: Jan. 13, 2022

(54) PRODUCTION OF ORGANIC FERTILIZER FROM AQUATIC ORGANISMS

(71) Applicant: GURRY INVESTMENTS, INC., Boston, MA (US)

(72) Inventor: Carl R. REETZ, Boston, MA (US)

(73) Assignee: GURRY INVESTMENTS, INC., Boston, MA (US)

(21) Appl. No.: 17/296,068

(22) PCT Filed: Nov. 6, 2020
(86) PCT No.: PCT/US20/59359

§ 371 Date: May 21, 2021

Related U.S. Application Data
(60) Provisional application No. 62/932,264, filed on Nov. 7, 2019.

(51) Int. Cl. C05F 1/00; C05D 1/02

(52) U.S. Cl. CPC C05F 1/002; C05D 1/02

(57) ABSTRACT

Disclosed is a method of producing a fertilizer from a marine source.

### CROSS-REFERENCE TO RELATED APPLICATIONS

This application claims the benefit of U.S. Provisional Application No. 62/932,264, filed Nov. 7, 2019, which is incorporated herein by reference in its entirety.

### FIELD OF THE INVENTION

The present invention is in the field of organic fertilizer.

### BACKGROUND OF THE INVENTION

Increased demand for organic fertilizer compositions, has resulted in development of new and/or better organic fertilizer compositions that provide the desirable and/or necessary nutrients, and the use of which reduces the risk of introducing pathogens into the food supply. To find a cost-efficient but enriching organic fertilizer composition, numerous attempts have been made to utilize waste products generated by fermentation and/or refined sugar processing as an organic fertilizer composition. For example, fish fertilizer has been manufactured from fermented fish carcasses. In traditional methods, fish fertilizers have been produced by hydrolyzing fish matter. The hydrolysis typically takes at least 30 to 60 days to naturally separate the hydrolysate (fertilizer) and the solid sediment. These methods are lengthy and cumbersome. Some traditional methods incompletely separate or fails to separate the fertilizer from the other components of the hydrolysate.

Thus, what is needed is a better method to manufacture organic fertilizers that is fast, efficient, and which ensures a high concentration of enriching fertilizer.

### SUMMARY OF THE INVENTION

It has been discovered that a certain method of disruption and digestion a of fish results in a superior and fast separation and preparation of useful fish components.

This discovery has been exploited to develop the present disclosure, which, in part, is directed to manufacture of fish fertilizer, raw materials for fish oil, and ground cover.

In one aspect, the present disclosure is directed to a method of producing a fertilizer, comprising: disrupting a marine-organism-based source material to obtain a slurry; enzymatically digesting the slurry to obtain a hydrolysate; and obtaining an aquatic component from the hydrolysate, the aquatic component comprising the fertilizer.

In some embodiments, the source material is from one specie of marine organism. In other embodiments, the source material is from more than one specie of marine organism. In a certain embodiment the siorec material is from a fish specie such as a fish with fins.

In some embodiments, the disrupting step comprises mechanically grinding the source material. In certain embodiments, particulate matter is removed from the source material before it is slurry before it is disrupted or before it is subjected to enzyme digestion.

In some embodiments, the enzymatic digestion comprises digesting the slurry with a protease. In certain embodiment, the protease is a Bacillus protease, and in particular embodiments, the protease is Subtilisin. Alcalase®, Protamex®, Flavourzyme®, Neutrase®, Protease A “Amano”, Pescalase®, Fromase™, Promod31™, Maxatase™ and/or Corolase.

In some embodiments, the method further comprises stabilizing the slurry with potassium sulfate (potash) to prevent growth of microorganisms.

In some embodiments, the aqueous component is separated from the hydrolysate by centrifugation.

In particular embodiments, the method further comprises obtaining a fatty component from the hydrolysate, the fatty component comprising a marine organism oil.

In certain embodiments, the method further comprises obtaining a sedimentary component from the hydrolysate.

### DESCRIPTION OF THE DRAWING

The foregoing and other objects of the present disclosure, the various features thereof, as well as the disclosure itself may be more fully understood from the following description, when read together with the accompanying drawings in which:

FIG. 1 is a diagrammatic representation of the method according to the disclosure; and

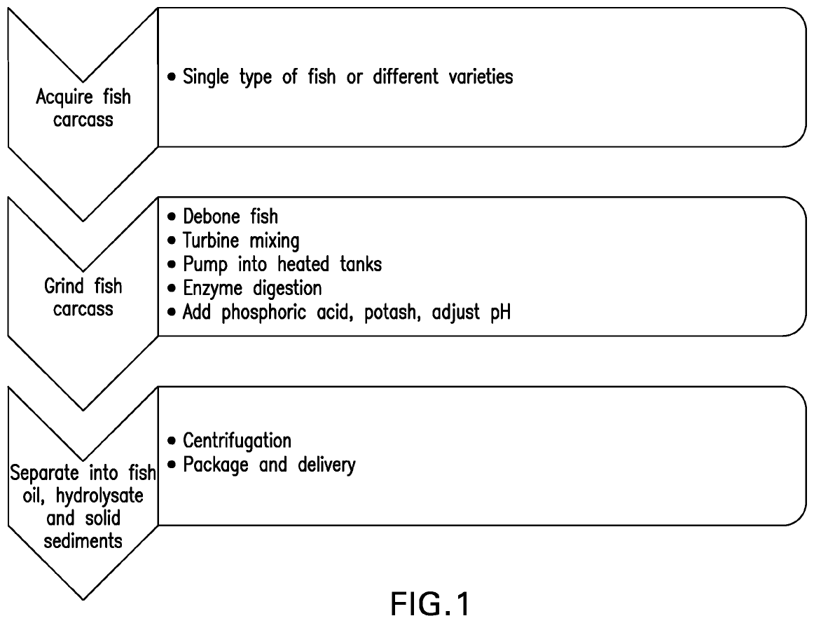

FIG. 2 is a schematic representation of one embodiment of the method according to the disclosure.

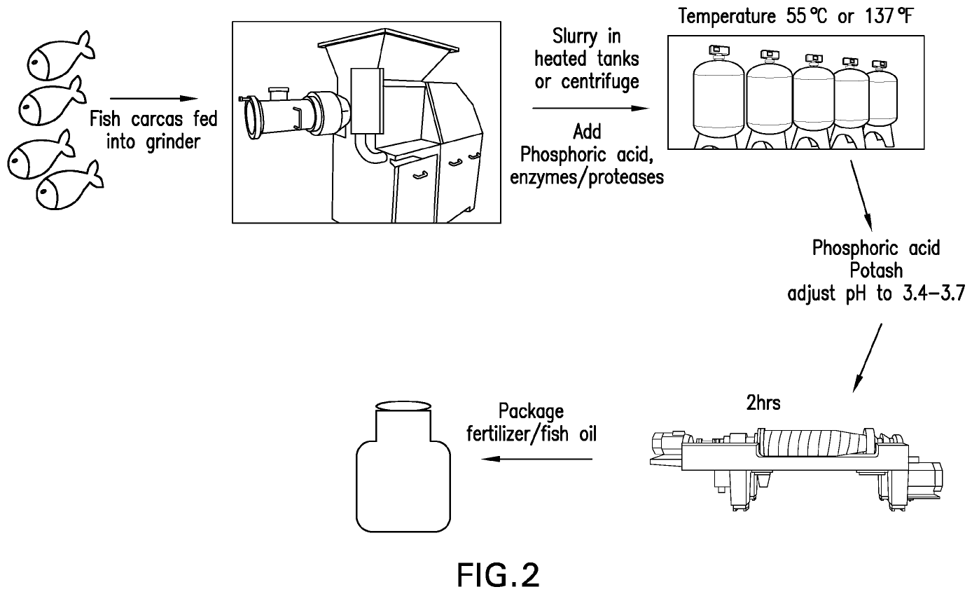

### DESCRIPTION

The disclosures of these patents, patent applications, and publications in their entireties are hereby incorporated by reference into this application in order to more fully describe the state of the art as known to those skilled therein as of the date of the invention described and claimed herein. The instant disclosure will govern in the instance that there is any inconsistency between the patents, patent applications, and publications and this disclosure.

Unless defined otherwise, all technical and scientific terms used herein have the same meaning as commonly understood by one of ordinary skill in the art to which this disclosure belongs. The initial definition provided for a group or term herein applies to that group or term throughout the present specification individually or as part of another group, unless otherwise indicated.

The term “marine source” refers to any species of marine organism that is useful as the starting or source material for producing the fertilizer.

The present disclosure relates to method of manufacturing an organic fertilizer from marine organism source. This process is efficient and results in a fertilizer enriched in nutrients and compositions useful for growing crops and other plants.

The method comprises disrupting the marine source to obtain a slurry, enzymatically digesting the slurry to obtain a hydrolysate, and then separating an aquatic component from the hydrolysate, the aquatic component comprising the fertilizer.

The marine organism source can be one specie or multiple species of marine organism such as fish, mollusks, and/or crustaceans. Useful fish species include those with fins such as, but are not limited to, cod, haddock, tuna dogfish, bluefish, salmon, and catfish. The marine source may be who bodies, carcasses, or portions thereof, such as, but not limited to, muscle, skin, viscera, bones, fish heads, other marine byproducts, and/or any combination thereof.

Disruption of the marine source can be accomplished by any method of grinding or mincing to obtain a slurry. Disruption may occur in the presence or absence of water. Useful disruption techniques include, but are not limited to, mechanical grinding with any commercially available grinder which may be fitted with a turbine. Large particulate matter such as skin, or bones optionally may be removed before or after disruption of organic starting material. About 5 liters to about 100 liters of 85% phosphoric acid may be used to stabilize the slurry to prevent the growth of microorganisms.

The resulting slurry is then enzymatically digested or hydrolyzed to obtain a hydrolysate. The slurry can be paced or pumped into a container such as a tank, e.g., 2.000 to 10,000 gallon steel tank, and then heated for this process.

Commercially available enzymes and/or proteases useful to digest the slurry include, but are not limited to, proteases from bacterial, fungal or marine species, such as a mixture of endo- and exo-proteases from Bacillus subtilis and Bacillus licheniformis, including Subtilisin, Alcalase®, Protamex®, Flavourzyme®, Neutrase®, Protease A “Amano”, Pescalase®. Fromase™, Promod3I™, Maxatase™ and Corolase. These proteases break down the complex aquatic animal protein into smaller peptides or amino acids. The temperature of the heated tank is adjusted to be permissible or optimum temperature for the enzyme/protease being used. For example, if the enzyme being used is Colorase, the temperature of the heated tank is about 55° C. Digestion is allowed to take place for about two hours, depending on the enzyme used to produce a hydrolysate. The enzyme reaction is terminated upon the addition of 85% food-grade phosphoric acid may added to a 5% final concentration.

The resulting hydrolysate may be supplemented with, e.g., a “natural” potassium sulfate that has no chlorine content (“Allganic potassium” or “Potassium 0-0-52” of potash) which aids with the budding of plants. Up to 2% (w/v) dry or powder form commercially available 85% food-grade phosphoric acid may also be added to a 5% final concentration for about one hour to stabilize pH to pH3.4-pH3.7 to prevent growth of microorganisms.

An aqueous component of the hydrolysate is then separated from the fatty component and any particulate component. This may be accomplished by centrifugation, e.g., using a commercially available centrifuge fitted with three spouts to drain three layers (e.g., Alfa Laval (Greenwood, Ind.). The hydrolysate centrifuge is spun at about 20K rpm to about 30K rpm for about one hour to about three hours at - - - temperature. The centrifugal forces separate the hydrolysate into three distinct components or layers, a lighter fatty component (top), an aqueous component (middle), and solid sediment component (bottom).

The aqueous component is isolated from the fatty component and sediment by centrifugation.

The fertilizer may be packaged into quart, half-gallon, or multiple gallon amounts in plastic or non-reactive containers.

The organic fertilizer according to the disclosure is comprised in this aqueous layer and is useful for organic farming and gardening. This fertilizer can be adsorbed through roots or foliage to promote vigorous plant health growth, increase agricultural crop yield and lengthen the productive life of perennial crops. Another advantage to manufacturing organic fertilizer according to this disclosure is that these fertilizers have an anti-freeze-effect, which can result in lengthening the growing season. The increase in plant health encourages diseases resistance, and combats infestations by pests. The manufacturing process of the organic fertilizer according to this application is free of unpleasant odor.

The solid sediment or bone meal layer can be used as ground cover to enhance the sprouting of seeds.

The fatty layer can be used as a source from which fish oil can be derived, as it is rich in omega-3-fatty acids. Omega-3-fatty acids have been used to help reduce the risk of heart disease and also to promote healthy skin. They are used along with diet and exercise to help lower levels of triglycerides and to raise levels of “good” cholesterol, also called high density lipoproteins (HDL). Omega-3-fatty acids are also implicated in reduction of inflammation, reducing the swollen and tender joints in patients with arthritis.

Reference will now be made to specific examples illustrating the disclosure. It is to be understood that the examples are provided to illustrate exemplary embodiments and that no limitation to the scope of the disclosure is intended thereby.

### EXAMPLES

### Example 1

### Manufacturing Process

15.000 pounds to 16,000 pounds of catfish carcasses are ground in a Bee Hive AM2C turbine grinder (Sandy, Utah) for two hours to obtain a slurry. The skin and bones (10% of total weight) are removed as waste). Optionally, about 5 liters to about 100 liters of 85% food-grade phosphoric acid (Inged.com, Wilkes-Barre, Pa.) are added to a 5% final concentration for about one hour are used to stabilize the fish slurry to prevent the growth of microorganisms.

The slurry is then pumped into 2,000 gallon-capacity metal tanks with a heated jacket and warmed to about 55° C. The slurry is digested with about 1% (v/v) to about 2% (v/v) Corolase 7089 (AB Enzymes, Damstadt, Germany Product 10021-1000) to hydrolyze the muscle proteins of the fish. The enzyme digestion is allowed to proceed for 30 minutes at about 55° C.

About 85% phosphoric acid (food-grade) is added to the hydrolysate to a final concentration of 5% (v/v) to stop the enzyme reaction. Potassium Sulfate of potash (Allaganic, Altanta, Ga.) is then added to a final concentration of 2% for 30 minutes. 85% food-grade phosphoric acid is added for an hour and the pH is adjusted to to about 3.4 to about 3.7. This process yields about 1,500 pounds to about 1,600 pounds of fish hydrolysate.

The hydrolysate is then centrifuged in an Alfa Laval (Greenwood, Ind.) centrifuge at a speed of 20 rpm to 30 rpm for 2 hours at room temperature (RT) to separate the hydrolysate into fatty (18%), aqueous (68%), and bone meal or sedimentary (6%) components.

The aqueous component is isolated from the other components by to (6%) be used as the fertilizer.

### EQUIVALENTS

Those skilled in the art will recognize, or be able to ascertain, using no more than routine experimentation, numerous equivalents to the specific embodiments described specifically herein. Such equivalents are intended to be encompassed in the scope of the following claims.

1. A method of producing a fertilizer, comprising:
a) disrupting amarine-organism-based source material to obtain a slurry;
b) enzymatically digesting the slurry to obtain a hydrolysate;
d) obtaining an aquatic component from the hydrolysate, the aquatic component comprising the fertilizer.

2. The method of claim 1, wherein the source material is from one specie of marine organism.

3. The method of claim 1, wherein the source material is from a fish specie.

4. The method of claim 1, wherein the disrupting step comprises mechanically grinding the source material.

5. The method of claim 1, wherein the enzymatic digestion comprises digesting the slurry with a protease.

6. The method of claim 6, wherein the protease is a Bacillus protease.

7. The method of claim 6, wherein the protease is Subtilisin, Alcalase®, Protamex®, Flavourzyme®, Neutrase®, Protease A “Amano”, Pescalase®, Fromase™, Promod31™, Maxatase™ and/or Corolase.

8. The method of claim 1, wherein particulate matter is removed from the source material before it is slurry before it is disrupted or before it is subjected to enzyme digestion.

9. The method of claim 1, further comprising stabilizing the slurry with potassium sulfate (potash) to prevent growth of microorganisms.
The method of claim 1, wherein the aqueous component is separated from the hydrolysate by centrifugation.

10. The method of claim 1, further comprising obtaining a fatty component from the hydrolysate, the fatty component comprising a marine organism oil.

11. The method of claim 1, further comprising obtaining a sedimentary component from the hydrolysate.
